(19) United States
(12) Patent Application Publication
(10) Pub. No.: US 2006/0161476 A1
(43) Pub. Date: Jul. 20, 2006

(54) System for acquisition of users

(76) Inventor: Meir Zohar, Givat Shmuel (IL)

Correspondence Address: DANIEL J SWIRSKY, 55 REUVEN ST., BEIT SHEMESH, 99544, IL

(21) Appl. No.: 11/037,471

(22) Filed: Jan. 19, 2005

(51) Int. Cl. G06Q 30/00

(52) U.S. Cl. 705/14; 705/26

(57) ABSTRACT

A system for bridging network services, the system including a first server computer providing a first service, a second server computer providing a second service, a bridge server, a first network client computer operative to create a session with the first service via a network and instruct the first service to broadcast to the bridge server information relating to the first client, a second network client computer having a promoter operative to create a session with the second service via the network, where the bridge server is operative to communicate the information to the second service, second service is operative to communicate the information to the promoter, and the promoter is operative to provide the information to a user. In another aspect of the present invention the information is pushed to the promoter.

### FIELD OF THE INVENTION

The present invention relates to user profiles in general, and more particularly to the acquisitions of users through a bridge server.

### BACKGROUND OF THE INVENTION

Commercial websites typically include as a measure of their success the number of distinct users of their service. Thus, commercial websites will often try to entice users to invite their friends to visit their website in order to boost this measure.

Since Internet users tend to coalesce into distinct groups, such as consumers that use the Internet to purchase consumer goods, software developers that browse the Internet for technical information, and researchers that utilize the vast amount of informational resources available on the Internet, web sites often have difficulty attracting new users outside of the group of users currently utilizing their service. Thus, a web site that caters to a first group of Internet users, such as consumers, may not be able to identify and reach a second group of users, such as researchers, without the help of a cross-user group, such as users that are both consumers and researchers.

### SUMMARY OF THE INVENTION

The present invention discloses a system and method for bridging network services.

In one aspect of the present invention a system is provided for bridging network services, the system including a first server computer providing a first service, a second server computer providing a second service, a bridge server, a first network client computer operative to create a session with the first service via a network and instruct the first service to broadcast to the bridge server information relating to the first client, a second network client computer having a promoter operative to create a session with the second service via the network, where the bridge server is operative to communicate the information to the second service, second service is operative to communicate the information to the promoter, and the promoter is operative to provide the information to a user. In another aspect of the present invention the information is pushed to the promoter.

In another aspect of the present invention the promoter is operative to pull the information from the second service.

In another aspect of the present invention the promoter is operative to visually display the information.

In another aspect of the present invention the promoter is operative to prompt the user with a request for a response to the information.

In another aspect of the present invention the second service is operative to redirect the second client to the first service for registration of a user of the second client with the first service.

In another aspect of the present invention the second service is operative to register a user of the second client with the first service.

In another aspect of the present invention the second service is operative to redirect the second client to the first service for communicating to the first service a user response to the information.

In another aspect of the present invention the second service is operative to communicate to the first service a user response to the information.

In another aspect of the present invention the information is an offer, and the promoter is operative receive from a user a response to the offer.

In another aspect of the present invention the response is a rejection of the offer, and the promoter is operative to query the user whether or not to install a resident agent on the second client for the purpose of receiving future offer notifications.

In another aspect of the present invention the promoter is operative to query the user for a set of preferences regarding the future notifications.

In another aspect of the present invention the system further includes a resident agent installed on the second client, operative to retain the preferences.

In another aspect of the present invention the resident agent is operative retain the user preferences and contact the second to receive other offers that match the preferences.

In another aspect of the present invention the system further includes a resident agent installed on the second client, where the resident agent is operative to offload information to the promoter, and the promoter is operative to present the information to a user in association with other information separately received by the promoter for presentation to the user.

In another aspect of the present invention the bridge server includes a queue operative to store and manage requests of items to be broadcast, and a campaign builder operative to monitor the queue for new requests and construct an advertising campaign with the information provided in each new request.

In another aspect of the present invention the queue is operative to assign a priority to any of the requests relative to any other of the requests.

In another aspect of the present invention the system further includes a creative server operative to receive the advertising campaign information from the campaign builder and determine the priority of the advertising campaign with respect to other advertising campaigns in a repository of existing advertising campaigns.

In another aspect of the present invention the system further includes a. broadcaster operative to receive a notification from the campaign builder that a new campaign is available from the creative server, and construct instructions suitable for the second client that describe the new campaign.

In another aspect of the present invention further includes an ad server operative to provide an advertisement to the second client and typically receive from the second client an indicator of effectiveness of the advertisement.

In another aspect of the present invention the ad server is operative to instruct the queue to remove any of the requests.

In another aspect of the present invention the ad server is operative to instruct the queue to reprioritize any of the requests in accordance with a predefined balance function for maintaining a balance between the number of the entries and expected reaction to the items for broadcast.

It is appreciated throughout the specification and claims that the term “advertisement” may refer to any form of communication between an advertiser and an audience, such as an audio and/or visual presentation.

### BRIEF DESCRIPTION OF THE DRAWINGS

The present invention will be understood and appreciated more fully from the following detailed description taken in conjunction with the appended drawings in which:

FIG. 1A is a simplified pictorial illustration of a system for bridging Internet services, constructed and operative in accordance with a preferred embodiment of the present invention;

FIG. 1B and 1C, taken together are simplified flowchart illustrations of a method for bridging Internet services, operative in accordance with a preferred embodiment of the present invention;

FIG. 2A is a simplified flowchart illustration of a method for installing a resident agent, operative in accordance with a preferred embodiment of the present invention;

FIG. 2B is a simplified flowchart illustration of a method communication between a resident agent and an advertising client, operative in accordance with a preferred embodiment of the present invention;

FIG. 3A is a simplified pictorial illustration of a bridge server, constructed and operative in accordance with a preferred embodiment of the present invention FIG. 3B is a simplified flowchart illustration of a method for building a personalized campaign, operative in accordance with a preferred embodiment of the present invention;

FIG. 4 is a simplified flowchart illustration of a method for matching broadcast requests with user preferences, operative in accordance with a preferred embodiment of the present invention;

FIG. 5 is a simplified flowchart illustration of a method for an operator to manage a broadcast, operative in accordance with a preferred embodiment of the present invention.

### DETAILED DESCRIPTION OF PREFERRED EMBODIMENTS

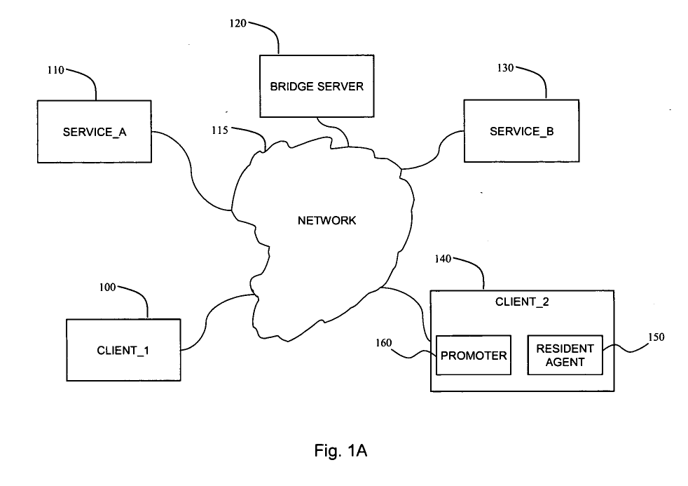

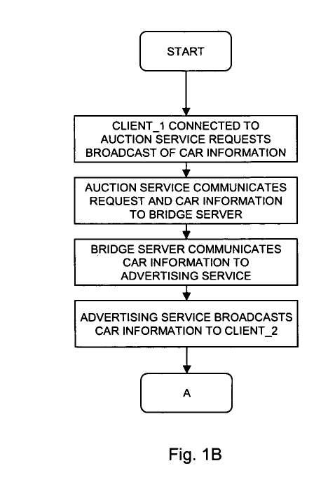

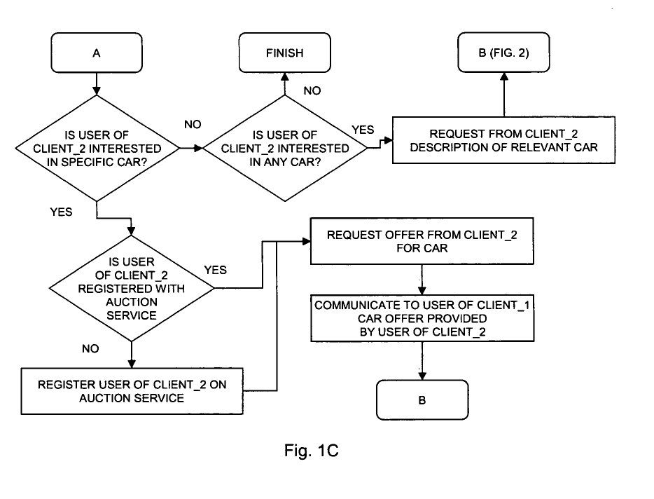

Reference is now made to FIG. 1A, which is a simplified pictorial illustration of a system for bridging network services, constructed and operative in accordance with a preferred embodiment of the present invention, and to FIG. 1B and 1C, which, taken together, is a simplified flowchart illustration of a method for bridging network services, operative in accordance with a preferred embodiment of the present invention. A first network client computer, Client 1 typically creates a session with a first server computer 110 providing a first service, Service A, over a network 115, such as the Internet. For example, a user of a first client computer 100, Client 1, may register with an auction service, such as eBay™ and instruct the eBay™ server to sell his car. Client 1 preferably instructs Service A to broadcast information, such as personal information. Thus, in the current example, client 1 may include information that describes the car in the instructions, such as digital images of the car.

Service A preferably communicates Client 1's instructions to a bridge server 120. Communication of information between services and servers is well known in the art and preferably takes the form of a Session Initiation Protocol (SIP) session whenever possible. Typically, a proprietary protocol is agreed upon between service A and bridge server 120, which is preferably encapsulated within the SIP session as is well known in the art. For example, the proprietary protocol may take the form of an XML document sent from the bridge server 120 to service A that may describe a set of queries to service A for additional particulars, such as a request for the geographic region in which client 1 resides.

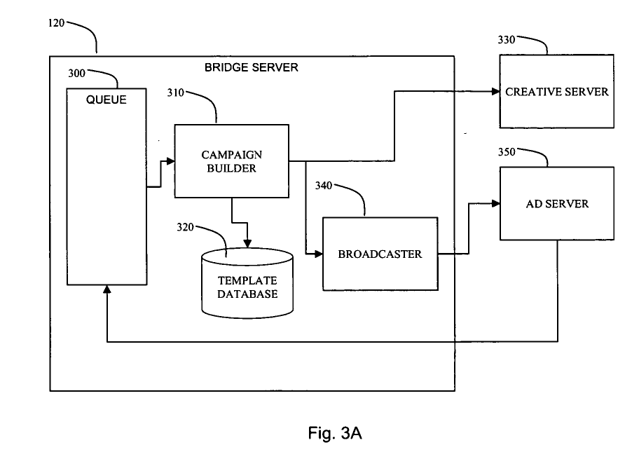

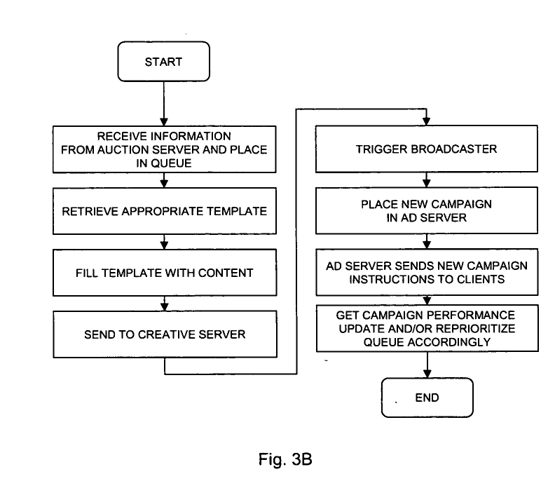

Bridge server 120 typically has one or more registered services, such as including a service, Service B, provided by a second server computer 130, which may be an advertising network, that are typically distinct from Service A, in that at any given moment few users concurrently utilize both Service A and Service B. Service B preferably provides Bridge Server 120 with a list of preferences that reflect the type of content suitable to Service B, a service such as where a dating service may only be interested in personal advertisements and not in car advertisements. Bridge server 120 preferably communicates the information received from Client 1 to Service B as well as any other relevant information, such as a list of similar cars for sale in the same geographic region, as described in more detail hereinbelow with reference to FIG. 3. Service B is typically capable of broadcasting information to a promoter 160 resident on a client computer 140, Client 2. Thus, in the current example, the auction service may communicate the car information to bridge server 120, which may in turn broadcast the car information over an advertising network, such as the Cydoor™ network, to multiple users, including promoter 160 resident on Client 2. Alternatively, promoter 160 may pull information from Service B. Promoter 160 is typically in periodic communication with the advertising network (i.e., Service B) and may receive advertisements from the advertising network for presentation to a user, one of which may be the car information originating at Client 1.

Promoter 160 preferably provides the information received from Service B to a user of Client 2, such as through the visual display of the information on the screen of Client 2. The user of Client 2 may be stimulated by the information originating from Client 1 to respond to Client 1. For example, Promoter 160 may promote the car information, e.g. display the digital images of the car, to a user of Client 2 and prompt the user with a request for a response, such as ‘are you interested in purchasing this car?’

The user of Client 2 is preferably asked by Service B to logon to Service A, or to register with Service A where the user has not previously done so. Service B preferably redirects Client 2 to Service A for registration, or may alternatively act as an intermediary in the registration of the user as a new user on Service A utilizing any known method in the art, such as a private HTTP registration protocol made available to Service B by Service A.

Promoter 160 preferably redirects Client 2 to Service A for further communication, such as enabling Client 2 to enter an offer for the car. Alternatively, promoter 160 may communicate the user's response, such as an offer to buy the car, to Service A via bridge server 120, with or without having Service B act as an intermediary.

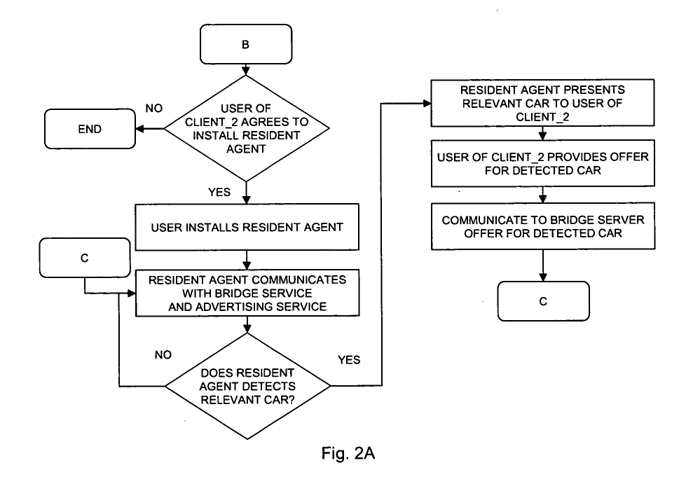

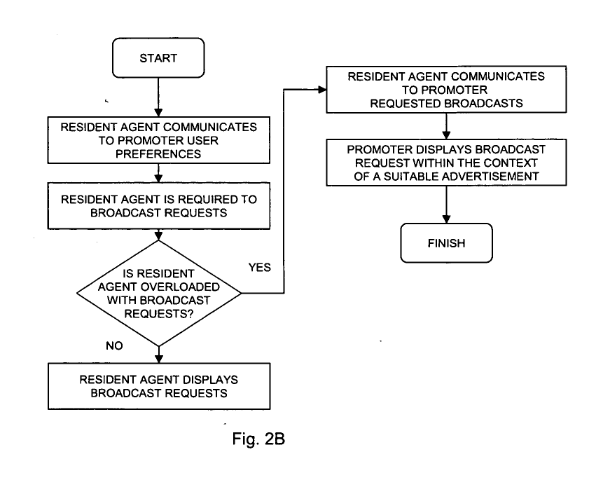

Typically, at the conclusion of the communication with Client 1 or Service A, promoter 160 invites the user of Client 2 to install a resident agent 150, as described in more detail hereinbelow with reference to FIG. 2A.

Should the user of Client 2 decline the current offer, promoter 160 preferably queries the user whether or not to install a resident agent on Client 2 for the purpose of receiving future offer notifications. Promoter 160 preferably queries the user of Client 2 for a set of preferences, which may relate to the information received from Client 1. Thus in the current example, promoter 160 may have the following dialogue with the user of Client 2:
Promoter: “Are you interested in this car at a different price?”
User: “Yes”
Promoter: “Please enter a price?”
User: “$3,500”
Promoter: “Would you like me to update you as soon as possible if the offer is accepted?”
User: “Yes”

Resident agent 150 preferably retains the user's preferences, such as the preferred price of $3,500 in the above example, and typically remains in contact with Service B to receive other offers that match the user's preferences using any user preference matching technique. The offer may then be provided to the user as described in greater detail hereinbelow.

Should the user of Client 2 respond in the affirmative, such as by expressing interest in purchasing the car in the current example, promoter 160 preferably attempts to effect the transaction. Thus, in the current example, promoter 160 ascertains if the user is already registered with the auction service of Service A, and, if so, promoter 160 may redirect the user to the auction service to complete the transaction. If the user is not registered, promoter 160 preferably mediates the registration process between the auction service and the user.

Alternatively, during the negotiation the user may completely decline the offer, and request a notification for a different product. For example:
Promoter “Are you interested in this car at a different price?”
User: “No”
Promoter: “Would you be interested in a different car?”
User: “Yes”
Promoter: “Please specify the car of interest.”
User: “Mazda 323, 2001, red”
Promoter: “Would you like me to update you as soon as possible if this car becomes available?”
User: “Yes”
   Promoter 160 may then communicate the user preferences to the advertisement network with a request for an update as soon as a product that matches the user preferences becomes available.

When the user requests further notification, promoter 160 preferably requests that the user install a resident agent to facilitate the future monitoring of notifications, as described in more detail hereinbelow with reference to FIGS. 2A and 2B.

Reference is now made to FIG. 2A, which is a simplified flowchart illustration of a method for installing a resident agent, operative in accordance with a preferred embodiment of the present invention, and to FIG. 2B, which is a simplified flowchart illustration of a method for communication between a resident agent and an advertising client, operative in accordance with a preferred embodiment of the present invention. In the method of FIG. 2A, the user of Client 2 agrees to install a resident agent 150. After installation, resident agent 150 typically communicates with bridge server 120, Service B or both, such as by requesting periodic updates. The nature of these periodic updates are preferably dependent on the user's preferences, such as the color or model of a car that interests the user, typically specified prior to the installation of the resident agent or at any later date, as described hereinabove with reference to FIG. 1C. Resident agent 150 may further retain a communication channel with promoter 160 and provide guidance to promoter 160, typically employing the user's preferences, as described in greater detail with reference to FIG. 2B.

Should resident agent 150 detect a suitable broadcast, i.e. a broadcast available through bridge server 120 that corresponds to a profile of the user of Client 2 as defined by the user's preferences, resident agent 150 preferably presents the broadcast to the user of Client 2 and solicits a response from the user of Client 2. The response to the broadcast is typically communicated to bridge server 120 by resident agent 150.

For example, promoter 160 may invite a user of Client 2 to join a chat session of a chat service, such as JDate™. The invitation may take the form of the rendering of a picture of the inviter and associated text, e.g. ‘would you like to join me?’. Should the user of Client 2 decline the invitation to join the chat session, promoter 160 may query the user of Client 2 for details of a chat session that would be of interest. The user of Client 2 may specify his/her personal preferences of chat sessions, e.g. the number of participates be greater than 3, two of which should have blond hair. Promoter 160 preferably will ask the user of Client 2 to install a resident agent 150 that will monitor available chat sessions and notify the user of Client 2 of any that match his/her criteria. After installation, resident agent 150 may communicate with bridge server 150, requesting a list of available chat sessions. Should resident agent 150 detect a match between an available chat session and the preferences of the user of Client 2, resident agent 150 preferably notifies the user of Client 2 of an available chat session that matches his/her profile, inviting the user of Client 2 to join a chat session that he/she indicated would be of interest.

Resident agent 150 may have a limited opportunity to display broadcast information. For example, the manufacturer of resident agent 150 may determine that if more than five broadcasts a day are displayed, an average user will uninstall resident agent 150. Should the resident agent 150 be required to display more than five broadcasts, the resident agent may offload the broadcast information to promoter 160 and request that promoter 160 present the information within the context of an advertisement suitable to the user of Client 2 preferences. In this way, it is promoter 160 that is presenting the information to the user, and not resident agent 150. Thus in the method of FIG. 2B, resident agent 150 may communicate to promoter 160 the preferences of the user of Client 2. Promoter 160 may utilize these preferences to retrieve advertisements for presentation to a user, and preferably presents the broadcast information received from resident agent 150 within the context of other information separately received by promoter 160 for presentation to the user. For example, if promoter 160 is currently presenting paid advertisements about a particular brand of car, and resident agent 150 offloads to promoter 160 a broadcast regarding tires for sale, promoter 160 may present the tire information while it is presenting the car advertisements.

Reference is now made to FIG. 3A, which is a simplified pictorial illustration of a bridge server, constructed and operative in accordance with a preferred embodiment of the present invention, and to FIG. 3B, which is a simplified flowchart illustration of a method for building a personalized campaign, operative in accordance with a preferred embodiment of the present invention. Bridge server 120 typically provides for a communication bridge between two types of services, such as Service A and Service B of FIG. 1A. In FIG. 3A, bridge server 120 includes a queue 300 to store and manage requests of items to be broadcast, such as a request from Service A as described hereinabove. Preferably, a campaign builder 310 monitors queue 300 for new requests and constructs an advertising campaign with the information provided in each new request as is well known in the art. Campaign builder 310 preferably communicates the advertising campaign to a creative server 330, either by transmitting the actual campaign content or by transmitting representative meta-content, such as a hyper-link to the campaign.

Creative server 330 preferably incorporates the newly constructed advertising campaign into its repository of existing advertising campaigns. The priority, and hence the subsequent promotion, of the newly constructed advertising campaign by promoter 160 is preferably determined by creative server 330, such as in accordance with techniques described in applicant/assignee's co-pending U.S. patent application Ser. No. 10/861,924 and entitled “A system for dynamic advertising in software applications,” incorporated herein by reference. Furthermore, campaign builder 310 preferably notifies a broadcaster 340 that a new campaign is available via creative server 330. Broadcaster 340 preferably constructs instructions suitable for Client 2 of Service B that describe the new campaign, such as in accordance with techniques described in applicant/assignee's co-pending U.S. patent application Ser. No. 10/861,924.

Client 2 preferably contacts an ad server 350 and requests advertisements and typically updates ad server 350 as to the effectiveness of the advertisements. The effectiveness of an advertisement may be measured with any standard measure well known in the art, such as clicks per million (CPM). Ad server 350 preferably instructs queue 300 to remove or prioritize requests. An advertisement's distribution, such as the frequency with which an advertisement is broadcast or the geographic distribution of the advertisement, is preferably a function of its priority. Queue 300 typically prioritizes an advertisement as a function of the financial remuneration to the owner of Ad Server 350, such as prioritizing advertisements that provide large commission relative to their distribution cost. For example, a twenty thousand dollar used car may provide a better commission to the owner of Ad Server 350 than a five thousand dollar used car, but may require extensive advertising to sell as opposed to the less expensive car. This mechanism preferably employs the relative effectiveness of the advertisements to help determine the distribution cost. For example, an advertisement that receives one click per million views is less effective than an advertisement that receives two clicks per million views. Thus, the priority of the first advertisement will be lowered relative to the second advertisement. Queue 300 may periodically receive new offers and typically removes older, non-relevant requests, such as when the item being advertised is no longer available. Queue 300 may furthermore maintain a balance between the number of requests and their respective potential audience. For example, for each offer queue 300 preferably balances the number of clients able to receive the offer with a predetermined probability that the offer will be accepted. For example, if the probability of acceptance for a particular offer is 1 in 100, the offer is only distributed to 100 clients. Queue 300 preferably keeps a set of other offers to distribute to other clients, so as to preserve a balance between the probability that any offer will be accepted and the number of clients.

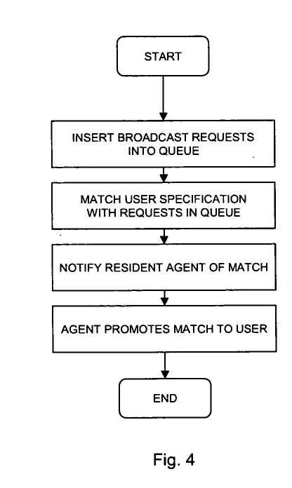

Reference is now made to FIG. 4, which is a simplified flowchart illustration of a method for matching broadcast requests with user preferences, operative in accordance with a preferred embodiment of the present invention. In the method of FIG. 4, a broadcast request inserted in queue 300 is matched with a user preference. Typically, the user preference originates from resident agent 150 as described hereinabove with reference to FIG. 2A. Should queue 300 find a match, the source of the user request, such as an originating resident agent 150, is preferably notified and the matching broadcast is typically communicated to the source for future display to the user. An example user preference may provide a profile of a prospective ‘date’ on a matchmaking service, such as a male between the ages of 20-25 residing in New York City or a user name John, and request notification to resident agent 150 when the matching user is online.

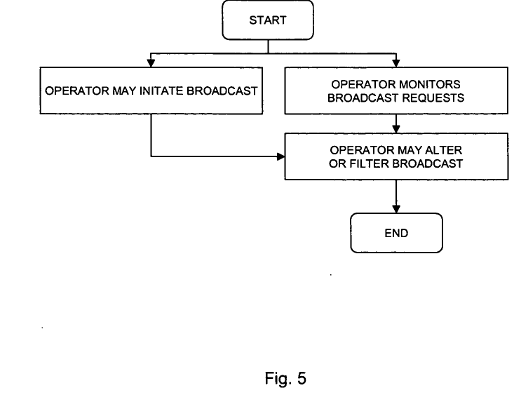

Reference is now made to FIG. 5, which is a simplified flowchart illustration of a method for managing a broadcast, operative in accordance with a preferred embodiment of the present invention. In the method of FIG. 5, an operator preferably monitors the broadcast requests, such as with the aid of a Graphical User Interface (GUI). Alternatively, an operator may initiate a broadcast with the aid of a Graphical User Interface (GUI). The operator may then alter or filter a broadcast prior to its distribution. For example, an operator may change the color of a broadcast to assess the sensitivity recipients of the broadcast may have to a specific color, or may decide that a particular broadcast includes unsuitable imagery and filter out the unsuitable imagery.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A system for bridging network services, the system comprising:
a first server computer providing a first service;
a second server computer providing a second service;
a bridge server;
a first network client computer operative to create a session with said first service via a network and instruct said first service to broadcast to said bridge server information relating to said first client;
a second network client computer having a promoter operative to create a session with said second service via said network,
wherein said bridge server is operative to communicate said information to said second service, second service is operative to communicate said information to said promoter, and said promoter is operative to provide said information to a user.

2. A system according to claim 1 wherein said information is pushed to said promoter.

3. A system according to claim 1 wherein said promoter is operative to pull said information from said second service.

4. A system according to claim 1 wherein said promoter is operative to visually display said information.

5. A system according to claim 1 wherein said promoter is operative to prompt said user with a request for a response to said information.

6. A system according to claim 1 wherein said second service is operative to redirect said second client to said first service for registration of a user of said second client with said first service.

7. A system according to claim 1 wherein said second service is operative to register a user of said second client with said first service.

8. A system according to claim 1 wherein said second service is operative to redirect said second client to said first service for communicating to said first service a user response to said information.

9. A system according to claim 1 wherein said second service is operative to communicate to said first service a user response to said information.

10. A system according to claim 1 wherein said information is an offer, and wherein said promoter is operative receive from a user a response to said offer.

11. A system according to claim 10 wherein said response is a rejection of said offer, and wherein said promoter is operative to query said user whether or not to install a resident agent on said second client for the purpose of receiving future offer notifications.

12. A system according to claim 11 wherein said promoter is operative to query said user for a set of preferences regarding said future notifications.

13. A system according to claim 11 and further comprising a resident agent installed on said second client, operative to retain said preferences.

14. A system according to claim 12 wherein said resident agent is operative retain said user preferences and contact said second to receive other offers that match said preferences.

15. A system according to claim 1 and further comprising a resident agent installed on said second client, wherein said resident agent is operative to offload information to said promoter, and wherein said promoter is operative to present said information to a user in association with other information separately received by said promoter for presentation to said user.

16. A system according to claim 1 wherein said bridge server comprises:
a queue operative to store and manage requests of items to be broadcast; and
a campaign builder operative to monitor said queue for new requests and construct an advertising campaign with the information provided in each new request.

17. A system according to claim 16 wherein said queue is operative to assign a priority to any of said requests relative to any other of said requests.

18. A system according to claim 16 and further comprising a creative server operative to receive said advertising campaign information from said campaign builder and determine the priority of said advertising campaign with respect to other advertising campaigns in a repository of existing advertising campaigns.

19. A system according to claim 16 and further comprising a broadcaster operative to receive a notification from said campaign builder that a new campaign is available from said creative server, and construct instructions suitable for said second client that describe said new campaign.

20. A system according to claim 16 and further comprising an ad server operative to provide an advertisement to said second client and typically receive from said second client an indicator of effectiveness of said advertisement.

21. A system according to claim 20 wherein said ad server is operative to instruct said queue to remove any of said requests.

22. A system according to claim 20 wherein said ad server is operative to instruct said queue to reprioritize any of said requests in accordance with a predefined balance function for maintaining a balance between the number of said entries and expected reaction to said items for broadcast.
